(19) United States
(12) Patent Application Publication
(10) Pub. No.: US 2022/0295788 A1
(43) Pub. Date: Sep. 22, 2022

(54) HIGH PERFORMANCE ANTIMICROBIAL COMPOSITION

(71) Applicant: Joseph H. JAMES, Brecksville, OH (US)

(72) Inventor: Joseph H. JAMES, Brecksville, OH (US)

(21) Appl. No.: 17/632,959

(22) PCT Filed: Apr. 30, 2021
(86) PCT No.: PCT/US2021/030125

§ 371 Date: Feb. 4, 2022

Related U.S. Application Data
(60) Provisional application No. 63/017,885, filed on Apr. 30, 2020.

(51) Int. Cl. A01N 33/12

(52) U.S. Cl. CPC A01N 33/12

(57) ABSTRACT

An antimicrobial composition is disclosed. The composition delivers several orders of magnitude improvement in the reduction of infectious materials (i.e., microbial substances, including bacteria, fungus, germs, and other pathogens). An organosilyl quaternary ammonium ion or salt is paired with a corresponding quaternary ammonium ion or salt at specific but extraordinarily low concentrations, so as to minimize any perceived harmful effects of these active ingredients while simultaneously delivering synergistic improvements to the efficacy of those active.

### CROSS REFERENCE TO RELATED APPLICATIONS

This application claims priority to U.S. provisional patent application Ser. No. 63/017,885 filed on Apr. 30, 2020, which is incorporated by reference herein.

### FIELD OF INVENTION

The invention relates to chemical compositions and, more specifically, to antimicrobial formulations that may serve as cleaning sprays and/or coatings providing superior protection against microbes, bacteria, germs, and other pathogens on various substrates within a very short time after application.

### BACKGROUND OF INVENTION

In addition to lacking the desired combination of low cost, low toxicity, and high efficacy, many conventional antimicrobial coatings and materials also fail provide greater than a 99.9% reduction of microbial load. Microbes of particular concern include bacteria such as Staphylococcus aureus (Staph), Escherichia coli (E. coli), Methicilllin-Resistant Staphylococcus aureus (MRSA) and Vancomycin-Resistant Enterecoccus faecalis and Enterobacter aerogenes (VRE) and other disease causing agents, such as viruses (and, of particular concern of late, coronavirus such as SARS-CoV-2).

Staphylococcus (Staph) is a group of bacteria, there are more than 30 types. Staph bacteria can cause many different types of infections, including; skin infections, food and blood poisoning. Most strains of Escherichia coli (E. coli) are not harmful but are part of the healthy bacterial flora in the human gut. However, some strains can cause various diseases, including pneumonia, urinary tract infections, diarrhea and meningitis. Some strains of E. coli infection can also cause nausea, vomiting and fever. Methicillin-Resistant Staphylococcus aureus (MRSA) is a type of bacterium that causes infections in different parts of the body. It is relatively more difficult to treat than most other strains of Staphylococcus aureus (staph) because it is resistant to antibiotics. It can cause serious skin, bloodstream, lungs or urinary tract infections. Vancomycin-Resistant Enterococci (VRE) are a type of bacteria called Enterococci that have developed resistance to many antibiotics, especially Vancomycin as the name suggests. These bacteria can cause serious infections, especially in people who are already ill or weak. VRE may cause bloodstream infection (sepsis), urinary infection, pneumonia, heart infections (endocarditis), or meningitis.

These are merely examples of various bacterial and microbial infections that are becoming increasingly common owing to over-use of antibiotics drugs and antibacterial soaps/sprays, the natural evolution of species, and the relative lack of viable, mass-produced bacteria- and microbial-free substrates (absent the use of drugs and/or soaps/sprays).

In the chemical industry, a 99.9% percent reduction in bacteria translates to a three order of magnitude reduction in bacterial and microbial risk (i.e., 3 log)—although even this level might not be enough as it does not completely inhibit the growth of microorganisms. Furthermore, existing antimicrobial coatings tend to deteriorate with time and lose effectiveness as contamination is repeated.

United States Patent Publication 2020/0068896 discloses a disinfecting cleaning composition. The composition includes a silane quaternary ammonium ion/salt serving as an antimicrobial in combination with one or more disinfectants, such as phenols, hydrogen peroxide, sodium hypochlorite, various other ammonium chlorides, and the like. The silane quaternary ammonium ion/salt must be provided in an amount greater than 0.05 wt. %, and the accompanying disinfectant(s) must be provided at an amount greater than 0.1 wt. %. The preferred composition is 3-(trimethoxysilyl)propyl dimethyl octadecyl ammonium chloride provided at 2.0 wt. %, isopropyl alcohol at 60 wt. %, and the remainder as deionized water. Other compositions contemplate a disinfectant that is actually a combination of quaternary ammonium chlorides, including at least one aromatic (i.e., dimethylbenzyl ammonium chloride).

U.S. Pat. No. 8,999,363 discloses methods and compositions for treating solid surfaces to impart antimicrobial and/or biocidal properties. Here, at least 4 wt. % of an organosilane quaternary ammonium chloride is provided with a different quaternary ammonium chloride compound at 2 wt. % or more. The preferred organosilane is (3-trimethoxysilyl)propyl tetradecyl dimethyl ammonium chloride, while the different quaternary compound is a mixture of C12, C14, and C16 alkyl dimethyl benzyl ammonium chloride and octyl decyl dimethyl, dioctyl dimethyl, and dodecyl dimethyl ammonium chlorides. An oxidizing agent (such as hydrogen peroxide), a chelating agent, and/or a stabilizing agent (such propylene carbonate, glycol ether, polyols, or sucrose) can also be employed.

United States Patent Publication 2016/0262382 describes a surface disinfectant with residual biocidal properties that relies upon an oxazoline polymer in combination with a disinfectant. The disinfectant can be a quaternary ammonium compound, silane quaternary salts, metals, alcohols, phenols, and a variety of acids and other known biocides.

United States Patent Publications 2018/0237642 and 2018/0105700 propose the use of inorganic bismuth-containing compounds for microbe-resistance. Similarly; United States Patent Publication 2017/0086455 describes a biocidal paint delivering a 3 log reduction in bacteria within two hours. Finally, U.S. Pat. No. 8,258,202 discloses a film-forming composition including a porous solid ion-exchange ceramic with pores containing anti-microbial metal ions in combination with a halogen ion-containing onium, while U.S. Pat. No. 8,877,256 provides an example of silver-based anti-microbial composition.

Still other conventional coating products claiming to deliver antibacterial properties include PaintGuard from the Sherwin Williams Company (Cleveland, Ohio); Alesta A M and Alesta Ralguard from Axalta (Philadelphia, Pa.) and Silversan from PPG (Pittsburgh, Pa.). However, these products generally claim to be 99.9% effective, taking 5 or more hours after application to reach their maximum efficiency. Existing products also tend to degrade over time, so that their active performance goes below 90% after recontamination (i.e., repeated exposure to pathogens in combination with routine environmental exposure and/or scrubbing/cleaning, sometimes in as little as a few days or weeks).

At a 90% protection level for a given coating, bacteria and germs have the ability to grow and respire. Thus, the 10% of the surviving population will continue multiplying to the point where existing pathogens on the substrate layer persist, thereby decreasing the efficacy of these coatings. In this context, any ten-fold improvement in protection will have a corresponding impact/improvement on the efficacy.

Previous efforts to increase effectiveness of antimicrobial coatings tended to rely on silver-based (e.g., silver nitrate) formulations. Such formulations aren't entirely satisfactory, as they only lead to a 3 log reduction that fails to completely inhibit respiration and regrowth of bacteria. This lack of effectiveness can probably be attributed to the fact that silver is used insufficient amounts and/or is unevenly dispersed throughout the composition, resulting in an inconsistent and, ultimately, ineffective distribution of anti-microbial particles within the composition/coating.

Any and all of the foregoing United States patents and publications are incorporated by reference, particularly with respect to the chemical structures and alleged efficacy of the anti-microbials disclosed therein.

An easy-to-use, cost-effective anti-microbial spray in which the vast majority (>95 wt. % or even >99 wt. %) of the composition is water and/or other inert compounds would be welcome, especially if such a spray also provided residual antimicrobial effects (e.g., a surface coating) for an extended period of time (>one month, >3 months, or possibly even up to one year). Further, a spray providing orders of magnitude greater efficacy in comparison to conventional 3 log coatings and sprays, particularly with respect to bacteria (e.g., staph) and other microbes, is needed.

### SUMMARY OF INVENTION

An antimicrobial coating composition is disclosed herein that is particularly advantageous because it reduces bacteria up to 99.9998% in comparison to untreated surfaces. This constitutes above five orders of magnitude or more (i.e., 5 log reduction), which is marked improvement over conventional antimicrobial products available today. Further, the inventive composition become effective in less than 60 minutes after being applied (and possibly in 5 minutes or less), so as to allow its use as a cleaning spray. Further, the composition is still able to prevent the spread of microbes on treated surfaces by forming a residual coating that does not immediately evaporate with the inert liquid, possibly for up to 90 days or more.

Further reference is made to the appended claims and description below, all of which disclose elements of the invention. While specific embodiments are identified, it will be understood that elements from one described aspect may be combined with those from a separately identified aspect. In the same manner, a person of ordinary skill will have the requisite understanding of common processes, components, and methods, and this description is intended to encompass and disclose such common aspects even if they are not expressly identified herein.

### DETAILED DESCRIPTION

Reference will now be made in detail to exemplary embodiments of the present invention. It is to be understood that other embodiments may be utilized and structural and functional changes may be made without departing from the respective scope of the invention. Moreover, features of the various embodiments may be combined or altered without departing from the scope of the invention. As such, the following description is presented by way of illustration only and should not limit in any way the various alternatives and modifications that may be made to the illustrated embodiments and still be within the spirit and scope of the invention.

Any elements described herein as singular can be pluralized (i.e., anything described as “one” can be more than one). Any species element of a genus element can have the characteristics or elements of any other species element of that genus. The described configurations, elements or complete assemblies and methods and their elements for carrying out the invention, and variations of aspects of the invention can be combined and modified with each other in any combination. As used herein, the words “example” and “exemplary” mean an instance, or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggests otherwise.

In certain aspects, the antimicrobial composition consists or comprises of a combination of complimentary, active salts are mixed with an antimicrobial liquid binder system that may be diluted with an inert liquid, such as water. The complimentary active salts include an organosilyl quaternary ammonium ion/salt and a corresponding quaternary ammonium ion/salt, both selected to have comparable length carbon chains (relative to the non-silyl branches of the organosilyl quaternary ammonium ion/salt), preferably provided, in total, at less than 5 wt. % and, more preferably, at less than 1 wt. % of the composition. The binder system will comprise <10 wt. %, <5 wt. %, and most preferably <3 wt. % of the total composition, although the binder should be present at an order of magnitude greater than the total combined amount of complimentary active salts. In all instances, the remainder of the composition is an inert liquid, capable of dispersing or dissolving these components. In some embodiments, water and, more specifically, distilled and/or deionized water may be used with particular effect.

Notably, the concentration of the organosilyl quaternary ammonium ion/salt should be an order of magnitude greater than the corresponding ammonium ion/salt. A preferred organosilyl quaternary ammonium ion/salt is octadecyl dimethyl (3-trihydroxysilyl propyl) ammonium chloride (CAS no. 19911-50-7, MW ˜454) provided at <10.0, <1.0, and <0.1 wt. % of the total composition (including inert components, such as water), with a nominal concentration of 0.05 wt. % specifically contemplated. A preferred corresponding quaternary ammonium ion/salt is octyl decyl dimethyl ammonium chloride (CAS no. 32426-11-2, MW ˜334) provided at <1.0, <0.1, and (most preferable)<0.01 wt. % of the total composition, with a nominal concentration of 0.005 wt. % specifically contemplated. The preferred remainder is water, with deionized water specifically included.

The antimicrobial coating disclosed herein is believed to deliver the following characteristics and advantages in comparison to currently available antimicrobial coatings:
Protection against the growth and adverse effects of various microbes, bacteria and germs Staph (Staphylococcus aureus), as well as E. coli (Escherichia coli), MRSA (Methicillin-Resistant Staphylococcus aureus), VRE (Vancomycin-Resistant Enterococcus faecalis and Enterobacter aerogenes), and others
A log reduction 5 or more (that is up to 99.9999%) effective in eliminating and reducing the growth of various microbes, bacteria, and germs.
Universally applicable to any substrate, including coatings, polymers, fabrics, and other hard surfaces.
Increased durability in comparison to conventional evaporative spray solutions, particularly in terms of recontamination and/or withstanding repeated cleaning and scrubbing, resulting in long-lasting protection against fungi, mold, and bacteria.
Free of Volatile Organic Compounds (VOC's) and/or known carcinogens such as benzyl or other aromatic containing compounds, thereby causing little to no toxic emissions, odor, or degradation of air quality.

The table below shows one example of an antimicrobial coating composition, including approximated weight ranges covering other embodiments of the invention. Any number within the disclosed range (up to the significant digits shown) is specifically disclosed, as well as all the various combinations and permutations of specific values for the various components. This exemplary formulation is specifically disclosed and contemplated. Relative ratios of various, specific components and subgroupings of components are both contemplated and disclosed in the table below.

TABLE 1
Exemplary formulations for antimicrobial composition useful
as a cleaner providing residual surface protection.

| Exemplary | Min/max | | |
|---|---|---|---|
| weight | range, wt. % | Component | Example |
| 0.050 | 0.01 to 1.0 | Organosilyl | Octadecyl dimethyl (3-trihydroxysilyl)propyl |
| | | quaternary | ammonium chloride |
| | | ammonium | |
| | | ion/salt | |
| 0.005 | 0.001 to 0.1 | Corresponding | Octyl Decyl dimethyl ammonium chloride |
| | | quaternary | |
| | | ammonium | |
| | | ion/salt (non-silyl) | |
| 99.945 | 98.9 to | Inert liquid | Water |
| | 99.999 | | |

Processing notes: All liquid components are thoroughly mixed and provided to an appropriate dispenser (e.g., trigger sprayer) for further use.

The ogranosilyl quaternary ammonium ion or salt will have a central nitrogen atom with four chains. Two of those four chains comprise simple, short, linear alkyl groups, preferably identical methyl groups. The third chain is a pendant alkyl group with a predetermined number of carbons. Preferably, the this pendant group is a linear carbon group. The fourth chain is necessarily silyl based, with a carbon connector leading to a silicon atom having three branches of identical terminal groups. Preferably, those identical terminal groups are hydroxyl, while the carbon connector is less than four carbons, with a propyl group being preferred. The compound itself can be complexed with chloride.

The corresponding quaternary ammonium ion or salt also has a central nitrogen atom with four chains. As above, two of those four chains comprise simple, short, linear alkyl groups, preferably identical methyl groups. The remaining two chains are linear alkyl chains where the total number of carbon in these chains is within 10% and, more preferably, identical to the number of carbons present in the pendant alkyl group of the organosilyl compound noted above.

The “binder system” consists of one or more comparatively common and low cost solvents, such as water, small chain alcohols, and the like. This system may include other optional components to improve the physical characteristics and, by extension, efficacy of the composition. By way of example rather than limitation, the boosters could be surfactants, catalysts, stabilizers, and the like.

In a further embodiment, the corresponding quaternary ammonium ion or salt compounds are provided. These corresponding quaternary ammonium ion or salt compounds have a central nitrogen atom with opposing linkages of carbon chains that form a long straight carbon chain. These long straight carbon chains are within 33% of the length, in terms of the total number of carbons, in comparison to organosilyl. More preferably, these long straight chains are between 12 and 22 carbons long (in total), with the two separate chains being of the same or slightly different (i.e., +/−4 carbons) length (e.g., octyl and decyl; octyl and octyl; decyl and decyl; etc.).

Further, both of the corresponding quaternary ammonium ion or salt compounds also have separate, shorter chains formed on opposing linkages of the nitrogen, thereby being positioned between the longer chain. These shorter chains are each individual less than four carbon atoms. More preferably, they are all methyl groups.

A binder system is again used. Here, the binder system preferably relies upon water as its primary (e.g., greater than 50 vol. %) or only solvent. The water can be distilled and/or deionized to minimize unwanted presence (and potential interference) by latent ionic species. Here, the binder system includes a booster that enhances the antimicrobial effects of the overall composition.

In this instance, the booster may include at least one, and possibly any combination of two or more, of the following antimicrobial agents: Hypochlorous acid; Isopropyl alcohol; Ethyl alcohol; n-alkyl (40% C12, 50% C14, 10% C16) dimethyl benzyl ammonium chloride; Dioctyl dimethyl ammonium chloride; Didecyl dimethyl ammonium chloride; n-octyl bicycloheptene dicarboximide; Piperonyl butoxide; Pyrethrins; 0-Phenylphenol; Hydrogen peroxide; Sodium hypochlorite; L-lactic acid; Citric acid; Glycolic acid; Ammonium bicarbonate; and Ammonium carbonate.

The corresponding quaternary compounds are provided at comparative orders of magnitude. Similarly, the booster in the binder system will be at least one, two, or even three orders of magnitude larger (in terms of weight of the composition) in comparison to the amount of the larger of the two quaternary compounds. Table 2 below provides further details, again with the same caveats regarding significant digits and substitutions as noted for Table 1 above.

TABLE 2
Exemplary formulations for antimicrobial composition useful
as a cleaner providing residual surface protection.

| Exemplary | Min/max | | |
|---|---|---|---|
| weight | range, wt. % | Component | Example |
| 1.80 | 1.30 to 3.0 | Antimicrobial | Example of Active Ingredients could consist of |
| | | Liquid Binder | the following constituents: n-alkyl (40% C12, 50% |
| | | System | C14, 10% C16) dimethyl benzyl ammonium |
| | | | chloride; |
| | | | Dioctyl dimethyl ammonium chloride; Didecyl |
| | | | dimethyl ammonium chloride; n-octyl |
| | | | bicycloheptene dicarboximide; Piperonyl |
| | | | butoxide; Pyrethrins; 0-Phenylphenol; Hydrogen |
| | | | peroxide; Sodium hypochlorite; L-lactic acid; |
| | | | Citric acid; Glycolic acid; Hypochlorous acid; |
| | | | Isopropyl alcohol; Ethyl alcohol; Ammonium |
| | | | bicarbonate; Ammonium carbonate |
| 0.050 | 0.01 to 1.0 | Organosilyl | Octadecyl dimethyl (3-trihydroxylsilyl)propyl |
| | | quaternary | ammonium chloride |
| | | ammonium | |
| | | ion/salt | |
| 0.005 | 0.001 to 0.1 | First | Octyl Decyl dimethyl ammonium chloride |
| | | corresponding | |
| | | quaternary | |
| | | ammonium | |
| | | ion/salt (non-silyl) | |
| 98.145 | 96.000 to | Inert liquid | Water (including distilled and/or deionized) |
| | 98.699 | | |

Processing notes: All liquid components are thoroughly mixed and provided to an appropriate dispenser (e.g., trigger sprayer) for further use.

In another embodiment, the antimicrobial booster could be provided at 0.700 wt. % with a three-part quaternary component: octyl decyl dimethyl ammonium chloride at 0.005 wt. %; dioctyl dimethyl ammonium chloride at 1.10 wt. %; and octadecyl dimethyl 3-(trihydroxysilyl propyl) ammonium chloride at 0.050 wt. %. In this formulation, with the balance being inert, such distilled and/or deionized water. Other non-reactive, known anti-microbial liquids (e.g., disinfecting alcohols, disinfecting simple solvents/acids, etc.) could be substituted or supplemented in the remainder. As such, the information in Tables 1 and 2, along with the foregoing narrative, can further supplement these possible formulations.

In all of the formulations, the inert liquid should be selected for cost and non-toxicity. As such, water—and particularly deionized water—is ideal. Because the vast majority of the overall composition consists of water, any negative effects of the active ingredients (i.e., the organosilyl and corresponding ammonium ions or salts) is minimized. Further, the liquid water makeup of the composition means that it can be easily dispensed, e.g., via a conventional trigger sprayer or other atomizer, so as to allow for quick and easy application. To ensure even better coverage, after spraying, the composition can be dispersed by wiping with a cloth or sponge. To the extent that cloth or sponge is also treated with/soaked in the composition, even better distribution of the composition can be achieved.

Similarly, the water-based nature of the composition allows it to be applied to hard surfaces as well as fabrics or other tortuous or uneven surfaces. Further, the amount of water used ensures that the substrate should not be damaged, especially in comparison to conventional anti-microbials that rely on bleach, alcohols, or other similar substances. Also, water is harmless upon evaporation, thereby avoiding problems that might otherwise be encountered when organic solvents and/or other volatile substances are used.

It should be noted that the preferred organosilyl compound is a proven antimicrobial in its own right. By pairing this organosilyl with the corresponding ammonium compound so that the total length of the main chain in each molecule is similar, the inventors believe it produces synergistic effects. While the extent of these synergistic effects is still under investigation, they are believed to include:
Expedited anti-microbial efficacy, with “kill” times of less than 1 hour proven and possibly being as short as less than 5 minutes or less than 1 minute after application of the compound.
Miscibility and ease of dispersing when the composition is initially mixed, as well as when it remains in storage for prolonged periods of time.
Broader spectrum anti-microbial effects. In addition to the known efficacy of the organosilyl quaternary ammonium compound, the preferred corresponding quaternary ammonium compound, octyl decyl dimethyl ammonium chloride, is one part of an mixture of ingredients found in the U.S. Environmental Protection Agency's List-N approved anti-microbials for certain coronaviruses, including SARS-COV-2. Thus, the inventors suspect that the corresponding quaternary ammonium compound, when used in conjunction with the primary organosilyl quaternary ammonium compound may deliver similar, broader efficacy.

Percent reduction is usually translated into log reduction by the following:
90% reduction=1 log reduction, i.e. 1,000,000 reduced to 100,000 is a 1 log reduction
99% reduction=2 log reduction, i.e. 1,000,000 reduced to 10,000 is a 2 log reduction
99.9% reduction=3 log reduction, i.e. 1,000,000 reduced to 1,000 is a 3 log reduction
99.99% reduction=4 log reduction, i.e. 1,000,000 reduced to 100 is a 4 log reduction
99.999% reduction=5 log reduction, i.e. 1,000,000 reduced to 10 is a 5 log reduction
99.9999% reduction=6 log reduction, i.e. 1,000,000 reduced to 1 is a 6 log reduction

The antimicrobial compositions according to this invention may attain up to a five or even six log reduction (according to the scale above). These compositions are is also specifically formulated to be directly applied via sprayer or atomizer on various substrate types such as plastic, metal, aluminum, wood, concrete, fabrics, paper, cloth, stucco, and a host of other materials to act as a shield against bacteria, germs and microbes. Further, it is not necessary to pretreat or apply primers to these substrates prior to the application of the antimicrobial composition. Examples of application areas include labs, ATM machines, ticketing machines, telephones, computers, public transport (seats, handrails), factories (changing areas, production), furniture, water filtration equipment, medical (pharmaceutical packaging), hospitals, school/childcare facilities, airports, restaurants, fitness equipment and any other high-touch areas that could benefit from disinfection.

In a first aspect, the invention is an antimicrobial composition having any combination of two or more of the following characteristics:
less then 10 wt. %, less than 5 wt. %, less than 1 wt. %, or between 0.10 to 1.00 wt. % (relative to the entire composition) of an organosilyl quaternary ammonium ion or salt having a pendant branch with a number of linear carbons;
a corresponding quaternary ammonium ion or salt having two straight carbon chain branches on opposing linkages of a central nitrogen atom, wherein a total number of carbon atoms in the two straight carbon chain branches is within 10% of the number of linear carbons in the pendant branch and wherein the corresponding quaternary ammonium ion or salt is provided in an amount that is at least an order of magnitude less than the organosilyl ammonium ion or salt in the composition;
a liquid binder system including an inert liquid, including or consisting of water and, more preferably, distilled and/or deionized water;
wherein the organosilyl ammonium ion or salt is an octadecyl dimethyl (3-trihydroxysily)propyl ammonium salt;
wherein the corresponding ammonium ion or salt is an octyl decyl dimethyl ammonium salt or dioctyl dimethyl ammonium salt;
wherein the total number of carbon atoms in the two straight carbon chain branches is identical to the number of linear carbon in the pendant branch and wherein the organosillyl and corresponding quaternary ammonium ions or salts each have two separate linear alkyl branches having fewer than four carbons each;
wherein the total number of carbon atoms in the two straight chain carbon branches is between 15 and 21 and wherein all of the two separate linear alkyl branches are identical;
wherein all of the two separate linear alkyl branches are methyl groups;
wherein the organosilyl quaternary ammonium ion or salt includes a silyl component having three separate hydroxyl groups appended thereto;
wherein the silyl component is joined to a nitrogen atom in an ammonium center by way of a carbon connector having less than 4 carbon atoms;
wherein the carbon connector is a propyl group;
wherein the oranogsilyl quaternary and/or the corresponding ammonium salt is/are a chloride salt;
wherein, within five minutes of application to a substrate, at least a four log reduction of microbes is realized on the substrate;
wherein, within one hour of application to a substrate, a four log reduction or greater of microbes is realized on the substrate pursuant to ASTM E2149;
wherein a plurality of corresponding quaternary ammonium ion or salt compounds are provided and wherein each given molecule of said plurality of corresponding quaternary ammonium ion or salt compounds have a pair of straight carbon chain branches on opposing linkages of a central nitrogen therein so that a total number of carbon atoms in the pair of straight carbon chain branches of the each given molecule is within 33% of the number of linear carbons in the pendant branch and wherein only a first molecule of the plurality of corresponding quaternary ammonium ion or salt compounds is provided in an amount that is at least an order of magnitude less than the organosilyl ammonium ion or salt in the composition;
wherein a second corresponding quaternary ammonium ion or salt compound and a third corresponding quaternary ammonium ion or salt compound are provided and wherein the corresponding, second, and third quaternary ammonium ion or salt compounds are all chemically distinct;
wherein the corresponding, second, and third quaternary ammonium ion or salt compounds are provided with each having between 12 and 20 carbon atoms, on a weight percentage basis, at differing orders of magnitude from one another;
wherein the organosillyl and the corresponding, second, and third quaternary ammonium ions or salts each have separate linear alkyl branches of fewer than four carbons;
wherein a booster provided to the inert liquid, the booster provided at 1.30 to 3.00 wt. % (relative to the entire composition);

Unless specifically noted, all tests and measurements are conducted in ambient conditions (e.g., temperature, pressure, humidity, etc.) according to commonly accepted measurement protocols (e.g., such as those regularly published by ASTM International) and relying upon commercially available instruments according to the manufacturer-recommended operating procedures and conditions. Specific tests and regimens identified by ASTM International may be particularly informative in characterizing the performance of the antimicrobial compositions contemplated herein, specifically including ASTM E2149 (Standard Test Method for determining the antimicrobial activity of antimicrobial agents under dynamic contact condition). Unless noted to the contrary (explicitly or within the context of a given disclosure), all mass measurements are in grams, temperature measurements in degrees Celsius, and all percentages based upon weight percentages. Molecular weights, to the extent provided but not specified, are weight averages unless the context of a particular disclosure dictates to the contrary.

Although the embodiments of this disclosure have been disclosed, it is to be understood that the present disclosure is not to be limited to just the described embodiments, but that the embodiments described herein are capable of numerous rearrangements, modifications and substitutions without departing from the scope of the claims hereafter. It is, of course, not possible to describe every conceivable combination of components or methodologies for purposes of describing the present specification, but one of ordinary skill in the art may recognize that many further combinations and permutations of the present specification are possible. Furthermore, to the extent that the term “includes” is used in either the detailed description or the claims, such term is intended to be inclusive in a manner similar to the term “comprising” as “comprising” is interpreted when employed as a transitional word in a claim. The claims as follows are intended to include all modifications and alterations insofar as they come within the scope of the claims or the equivalent thereof.

We claim:

1. An antimicrobial composition consisting essentially of:
less than 10 wt. % of an organosilyl ammonium ion or salt having a pendant branch with a number of linear carbons;
a corresponding quaternary ammonium ion or salt having two straight carbon chain branches on opposing linkages of a central nitrogen atom, wherein a total number of carbon atoms in the two straight carbon chain branches is within 10% of the number of linear carbons in the pendant branch and wherein the corresponding quaternary ammonium ion or salt is provided in an amount that is at least an order of magnitude less than the organosilyl ammonium ion or salt in the composition; and
a remainder of a binder system including an inert liquid.

2. The antimicrobial composition of claim 1 wherein the organosilyl ammonium ion or salt is provided at less than 0.1 wt. %.

3. The antimicrobial composition of claim 2 wherein the organosilyl ammonium ion or salt is an octadecyl dimethyl (3-trihydroxysily)propyl ammonium salt.

4. The antimicrobial composition of claim 1 wherein the corresponding ammonium ion or salt is an octyl decyl dimethyl ammonium salt.

5. The antimicrobial composition of claim 4 wherein the corresponding ammonium salt is provided at about 0.005 wt. %.

6. The antimicrobial composition of claim 1 wherein the total number of carbon atoms in the two straight carbon chain branches is identical to the number of linear carbon in the pendant branch and wherein the organosillyl and corresponding quaternary ammonium ions or salts each have two separate linear alkyl branches having fewer than four carbons each.

7. The antimicrobial composition of claim 6 wherein the total number of carbon atoms in the two straight chain carbon branches is between 15 and 21 and wherein all of the two separate linear alkyl branches are identical.

8. The antimicrobial composition of claim 7 wherein all of the two separate linear alkyl branches are methyl groups.

9. The antimicrobial composition of claim 8 wherein the organosilyl quaternary ammonium ion or salt includes a silyl component having three separate hydroxyl groups appended thereto and wherein the silyl component is joined to a nitrogen atom in an ammonium center by way of a carbon connector having less than 4 carbon atoms.

10. The antimicrobial coating composition of claim 1 wherein a plurality of corresponding quaternary ammonium ion or salt compounds are provided and wherein each given molecule of said plurality of corresponding quaternary ammonium ion or salt compounds have a pair of straight carbon chain branches on opposing linkages of a central nitrogen therein so that a total number of carbon atoms in the pair of straight carbon chain branches of the each given molecule is within 33% of the number of linear carbons in the pendant branch and wherein only a first molecule of the plurality of corresponding quaternary ammonium ion or salt compounds is provided in an amount that is at least an order of magnitude less than the organosilyl ammonium ion or salt in the composition.

11. The antimicrobial coating composition of claim 1 wherein the inert liquid consists essentially of distilled or deionized water.

12. The antimicrobial coating composition of claim 11 wherein the binder system includes an antimicrobial booster selected from: n-alkyl (40% C12, 50% C14, 10% C16) dimethyl benzyl ammonium chloride; Dioctyl dimethyl ammonium chloride; Didecyl dimethyl ammonium chloride; n-octyl bicycloheptene dicarboximide; Piperonyl butoxide; Pyrethrins; 0-Phenylphenol; Hydrogen peroxide; Sodium hypochlorite; L-lactic acid; Citric acid; Glycolic acid; Hypochlorous acid; Isopropyl alcohol; Ethyl alcohol; Ammonium bicarbonate; Ammonium carbonate; and a combination of any two or more thereof.

13. The antimicrobial coating composition of claim 12 wherein, relative to a weight of the composition, the binder system is provided at between 1.30 and 3.00 wt. %, the organosilyl ammonium ion or salt is provided at between 0.01 to 1.00 wt. %, and the corresponding quaternary ammonium ion or salt is provided at between 0.001 and 0.010 wt. %.

14. The antimicrobial coating composition of claim 13 wherein the organosilyl ammonium ion or salt consists of octadecyl dimethyl (3-trihydroxylsilyl)propyl ammonium chloride and the corresponding ammonium ion or salt consists of octyl decyl dimethyl ammonium chloride.
